(19) United States
(12) Patent Application Publication
(10) Pub. No.: US 2015/0311019 A1
(43) Pub. Date: Oct. 29, 2015

(54) SAFETY SWITCHING DEVICE

(71) Applicant: Pilz GmbH & Co. KG, Ostfildern (DE)

(72) Inventors: Sabine MAYER, Ostfildern (DE); Markus CECH, Ostfildern (DE); Andreas VEIT, Ostfildern (DE)

(21) Appl. No.: 14/794,246

(22) Filed: Jul. 8, 2015

Related U.S. Application Data
(63) Continuation of application No. PCT/EP2014/050750, filed on Jan. 16, 2014.

(30) Foreign Application Priority Data
Jan. 16, 2013 (DE) 10 2013 100 441.5

(51) Int. Cl. H01H 47/00

(52) U.S. Cl. CPC H01H 47/005

(57) ABSTRACT

A safety switching device for controlling a technical installation in an automated manner, said safety switching device having a housing, at least one input for receiving an input signal, at least one processing unit for processing the input signal and generating a control signal and also at least one output for outputting the control signal to an actuator, wherein the safety switching device further comprises an RJ interface arranged at the housing as a user interface for the safety switching device, wherein a first bar is provided on a first side of the RJ interface and a second bar is provided on an opposite second side of the RJ interface, wherein the first and the second bar protrude from the housing and serve for mounting a securing element thereto.

### CROSS REFERENCES TO RELATED APPLICATIONS

This application is a continuation of international patent application PCT/EP2014/050750, filed on Jan. 16, 2014 designating the U.S., which international patent application has been published in German language and claims priority from German patent application DE 10 2013 100 441.5, filed on Jan. 16, 2013. The entire contents of these priority applications are incorporated herein by reference.

### BACKGROUND OF THE DISCLOSURE

The disclosure relates to a safety switching device for controlling a technical installation in an automated manner, said safety switching device having a housing, at least one input for receiving an input signal, at least one processing unit for processing the input signal and generating a control signal, and at least one output for outputting the control signal to an actuator, wherein the safety switching device further comprises on the housing an RJ interface as a user interface for the safety switching device.

The operating manual “PNOZ mOp, PNOZmulti Modular Safety System, Operating Manual—No. 1002053-EN-03, Pilz GmbH & Co. KG” of the applicant discloses an exemplary safety switching device. This safety switching device is a safety switching device for switching off an electrical consumer in a failsafe manner and in particular for switching off in a failsafe manner a machine of an automated installation that poses a risk to humans. This safety switching device is marketed by the applicant under the trademark PNOZ®. This safety switching device comprises two redundant signal processing channels.

Safety switching devices of this type are used particularly in the industrial field in order to switch on and off in a safe manner electrically driven machines, such as by way of example a press or a milling tool. Said safety switching devices are used in particular in conjunction with a mechanically actuable emergency off button that in an emergency situation switches the machine off in a rapid and safe manner. For this purpose, the current supply of the machine that is to be switched off is supplied by way of working contacts from two electromechanical switching elements. As soon as only one of the two switching elements opens its working contacts, the current supply to the machine is interrupted.

Furthermore, a safety switching device in terms of the present disclosure is by way of example also a modular assembly for a programmable controller, for instance a programmable controller as is marketed by the applicant under the trademark PSS®. In particular PSSuniversal® offers a modular programmable control unit for standard tasks and safety-related tasks, such as are known from the description “Pilz, PSSuniversal, Programmable Control Systems PSS®, System Description, No. 21256-EN-04”.

Safety switching devices of this type that are constructed and can be configured in a modular manner frequently comprise user interfaces that allow the user to transmit and evaluate status data and/or error messages via Ethernet. Furthermore, user interfaces of this type render it possible to program and parameterize the safety switching device via Ethernet and consequently via external devices. Moreover, visualization systems can be connected directly via user interfaces of this type. Frequently, so-called RJ interfaces (“Registered Jack”) standard interface according to Federal Communications Commission (FCC) are used as a user interface for safety switching devices of this type. A common and preferred interface is the RJ45 interface that is also known colloquially as an “Ethernet interface”.

The variability and facility to connect in a simple manner RJ interfaces of this type have proved to be extremely advantageous. Laptops, desktops or other external programming devices and reading devices can be connected in this manner very easily to the safety switching device. On the other hand, the safety requirements placed on safety switching devices of this type are enormously large. Any manipulation of the safety switching device can have devastating results. Since RJ interfaces of this type are relatively easy to “tap into”, undesired manipulations are possible. A further problem that has arisen when using RJ interfaces of this type with safety switching devices is the fact that said RJ interfaces are in part only slightly protected against vibration and consequently the associated reliability of the contact is low.

### SUMMARY OF THE INVENTION

It is an object to provide a safety switching device that is improved in particular with regard to the protection against undesired manipulation and its ability to be connected to external devices.

In accordance with an aspect of the present disclosure, a safety switching device is presented which comprises: a housing; an input which is configured to receive an input signal; a processing unit which is configured to process the input signal and to generate a control signal; an output which is configured to output the control signal to an actuator; an RJ interface arranged at the housing; a first bar which is arranged on a first side of the RJ interface, wherein the first bar comprises a first section that protrudes from the housing and a second section that extends transverse to said first section, wherein the second section is arranged on an end of the first section that is remote from the housing; and a second bar which is arranged on a second side of the RJ interface opposite the first side, wherein the second bar comprises a third section that protrudes from the housing and a fourth section that extends transverse to said third section, wherein the fourth section is arranged on an end of the third section that is remote from the housing.

In accordance with a further aspect of the present disclosure a safety switching device for controlling a technical installation in an automated manner is presented which comprises: a housing; an input which is configured to receive an input signal; a processing unit which is configured to process the input signal and to generate a control signal; an output which is configured to output the control signal to an actuator; an RJ interface comprising one or more contacts and being arranged at the housing; a first bar which protrudes from the housing and is arranged on a first side of the RJ interface; a second bar which protrudes from the housing and is arranged on a second side of the RJ interface opposite the first side; and a protective cover for covering the RJ interface, wherein the protective cover comprises a hinged flap which is pivotally supported on the housing by means of an articulated joint having an articulated axle, wherein the articulated axle extends transverse to the first and the second bar. The housing comprises a recess that extends between the first and the second bar, and wherein both the RJ interface and the articulated axle are arranged in the recess on a first side of an imaginary center line of said recess, wherein said imaginary center line extends transverse to the first and second bar and divides the recess in two parts of equal size.

In accordance with a further aspect of the present disclosure a safety switching device for controlling a technical installation in an automated manner is presented which comprises: a housing; an input which is configured to receive an input signal; a processing unit which is configured to process the input signal and to generate a control signal; an output which is configured to output the control signal to an actuator; an RJ interface arranged at the housing; a first bar which protrudes from the housing and is arranged on a first side of the RJ interface; a second bar which protrudes from the housing and is arranged on a second side of the RJ interface opposite the first side; and a securing element which is mounted to the first bar and the second bar, wherein the securing element comprises a cable tie or a seal.

Bars of this type that are preferably arranged to the side of or adjacent to the RJ interface simplify the mounting of a securing element. Possible securing elements are by way of example cable ties, seals or similar securing elements. A securing element that is arranged in this manner on the bars has multiple functions and associated advantages. By way of example, access to the RJ interface is prevented by virtue of attaching a seal or a cable tie to the bars. Even though the seals or cable ties can also be removed, this nonetheless increases the manipulation protection of the safety switching device. In particular in the case of a seal, there is visible evidence that the RJ interface and consequently also the safety switching device have not been undesirably manipulated. A cable tie that is mounted on the bars also demonstrates that the RJ interface should not be accessible to unauthorized persons.

Cable ties or seals of this type can be attached to the bars in a relatively simple manner. Since these bars protrude from the housing of the safety switching device, the cable ties or seals can be wound around the bars in a simple manner and thus prevent access to the RJ interface.

Furthermore, the facility to attach a cable tie or any other securing element to the mentioned bars has a further advantage. In the case of an RJ plug that is inserted into the RJ interface, said RJ plug can be additionally secured with the aid of the securing element that is fastened to the bars. This increases on the one hand the contact reliability between the RJ plug and the RJ interface (RJ socket), as will be explained in detail hereinafter. On the other hand, this renders it possible to prevent the RJ plug from being undesirably removed from the RJ socket during reading out from the safety switching device or during programming or parameterizing the safety switching device. The securing element can thus also be used as vibration protection.

In a refinement, the first bar comprises a first section that protrudes from the housing and a second section that extends transverse to said first section, wherein the second section is arranged on an end of the first section that is remote from the housing, and wherein the second bar comprises a third section that protrudes from the housing and a fourth section that extends transverse to said third section, wherein the fourth section is arranged on an end of the third section that is remote from the housing.

It shall be noted that the terms “first section”, “second section”, “third section”, and “fourth section” are herein only used to distinguish between the different sections of the bars denoted as first and second bar. In fact, each bar comprises two such sections. The first bar comprises the first and the second section. The second bar comprises the third and the fourth section. The first section of the first bar corresponds to the third section of the second bar and is arranged parallel thereto. The second section of the first bar corresponds to the fourth section of the second bar and is arranged parallel thereto. The first section of the first bar preferably extends in an essentially perpendicular manner with respect to the second section of the first bar. The third section of the second bar preferably extends in an essentially perpendicular manner with respect to the fourth section of the second bar. This produces an essentially L-shaped profile of the two bars. It is preferred that both the first and also the second bar each an essentially L-shaped profile. An L-shaped profile of this type has the advantage that it is virtually impossible for the securing element to be undesirably released. Owing to the fact that the second section and the fourth section extend in a transverse manner with respect to the first section and the third section, each bar comprises a sideward protrusion on its upper face remote from the housing so that a cable tie that is tensioned between the bars or a seal that is provided between said bars cannot be removed from the bars from above. The second section and the fourth section function so to speak as restraining elements or barbs. In order to be able to remove a cable tie that is wound around the two bars and consequently to gain access to the RJ interface, it is therefore necessary to intentionally break said cable tie. In the event of a seal being broken, this would be clearly visible to the further user so that said user would receive an alarm signal indicating that the safety switching device has possibly been manipulated.

In a further refinement, wherein the second section extends, starting from the first section, along a first direction, an wherein the fourth section extends, starting from the third section, along a second direction opposite the first direction

It is preferred that the second section and the fourth section when viewed from the RJ interface are directed outwards, in other words away from one another. In this manner, the bars jointly imitate the shape of a cable drum so that a securing element can be wound around or tensioned around the bars in a relatively simple manner.

In a further refinement, a protective cover for covering the RJ interface is arranged on the housing and can be opened and closed.

A protective cover of this type is used essentially as a dust protector for the RJ interface while said RJ interface is not in use. In order to open or close the protective cover, it is possible to provide by way of example a hinged protective cover but also to provide displaceable or removable protective covers. The protective covers can be configured both as a single part component and also as a multi-part component.

In a further refinement, the protective cover is configured as a protective flap that can be flipped open and flipped closed by way of an articulated axle that extends transverse to the first and second bar.

A hinged protective cover has in particular the advantage that even in the open state the protective flap performs a further securing function in the case of an inserted RJ cable. In combination with the already mentioned cable tie as a securing element, an RJ cable that is inserted into the RJ interface can namely be additionally secured in a mechanical manner. A cable tie that is tensioned around the bars not only surrounds the bars in this case but rather also surrounds the RJ cable and the flipped-open protective flap. The protective flap is additionally pressed against the RJ cable by means of the cable tie. As a consequence, further pressure is exerted on the RJ cable resulting in the RJ cable being held in a mechanically secure manner in the RJ interface so that said cable is not undesirably removed. When the protective flap is in the closed state and the cable tie or seal are mounted in place, the blocking securing element prevents the protective flap being opened so that access to the RJ interface is prevented in this case.

In a further refinement, the protective flap is made of an elastic material.

This has the advantage that in the case of the protective flap being pressed down, as described above, with the aid of the cable tie against the RJ cable, the protective flap itself is not damaged. The protective flap can still be used even after the securing element, in other words for example the seal or the cable tie, has been removed. Consequently, pressure that is permanently exerted on the protective flap does not cause said protective flap to deform undesirably.

In a further refinement, the RJ interface is arranged in the housing in a recess that extends between the first and the second bar, wherein contacts of the RJ interface and the articulated axle of the protective flap are arranged on a same side of the recess.

An RJ cable that is inserted into the RJ interface (RJ socket) and is mechanically secured in the above described manner with the aid of the securing element is automatically easily tilted by means of the protective flap that is flipped open and presses against the cable. Since the contacts of the RH interface and the articulated axle of the protective flap are arranged on one and the same side of the recess, the contacts of the RJ plug are automatically pressed against the contacts of the RJ interface by means of the tilting moment that has been produced. This increases the contact reliability of the RJ plugsocket connection. Since vibrations can quite easily occur at the mentioned safety switching devices during the operation, it is an enormous advantage to have an increased contact reliability of this type since it is easier to read, program or parameterize during the running operation. An interruption of the contacts of the RJ connection is thus rather improbable.

In a further refinement, the first section of the first bar and the third section of the second bar lead into the recess or adjoin said recess.

It is preferred that the two bars lead on opposite sides into the recess. The two bars preferably protrude perpendicularly from the housing surface. The fact that the two bars directly adjoin the recess in which the RJ interface is arranged has in particular the advantage of a space-saving arrangement. However, it goes without say that the two bars can also be arranged at a particular distance from the recess. In order that the securing element that is fastened to the bars spans the RJ interface in order in the opened state to secure the RJ plug and in the closed state to prevent access to the RJ interface, it is merely necessary that the two bars are arranged on opposite sides of the RJ interface. Although it is not absolutely necessary for the two bars to be flush with one another, this does however make it easier to attach the securing elements.

It goes without saying that the above mentioned features and the features that are yet to be mentioned hereinafter can be used not only in the respective disclosed combination but also in other combinations or stand-alone without departing from the spirit and scope of the present disclosure.

### BRIEF DESCRIPTION OF THE DRAWINGS

FIG. 1 illustrates a simplified view of a technical installation in order to explain the manner in which the safety switching device in accordance with the disclosure functions,

FIG. 2 illustrates a first perspective view of an exemplary embodiment of the safety switching device in accordance with the disclosure,

FIG. 3 illustrates a second perspective view of the safety switching device illustrated in FIG. 2,

FIG. 4 illustrates a detailed view of the safety switching device illustrated in FIG. 2,

FIG. 5 illustrates a view from above of the safety switching device illustrated in FIG. 2 in this instance in a first state (with closed protective flaps),

FIG. 6 illustrates a further view from above of the safety switching illustrated in FIG. 2 in this instance in a second state (with open protective flaps),

FIG. 7 illustrates a further detailed view of the safety switching device illustrated in FIG. 2 in this instance with the RJ plugs connected, and

FIG. 8 illustrates a further view from above of the safety switching device illustrated in FIG. 2 in this instance with RJ plugs connected.

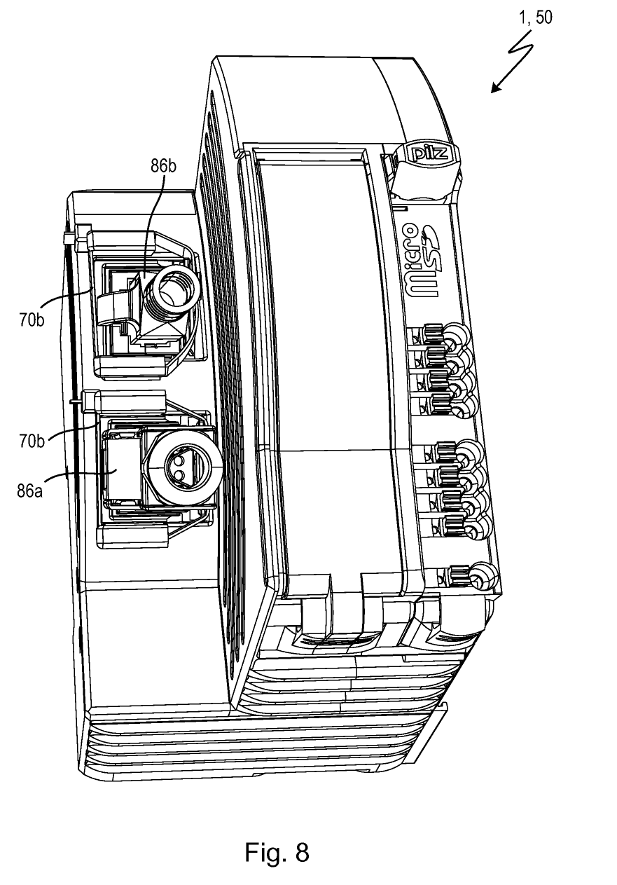

### DESCRIPTION OF PREFERRED EMBODIMENTS

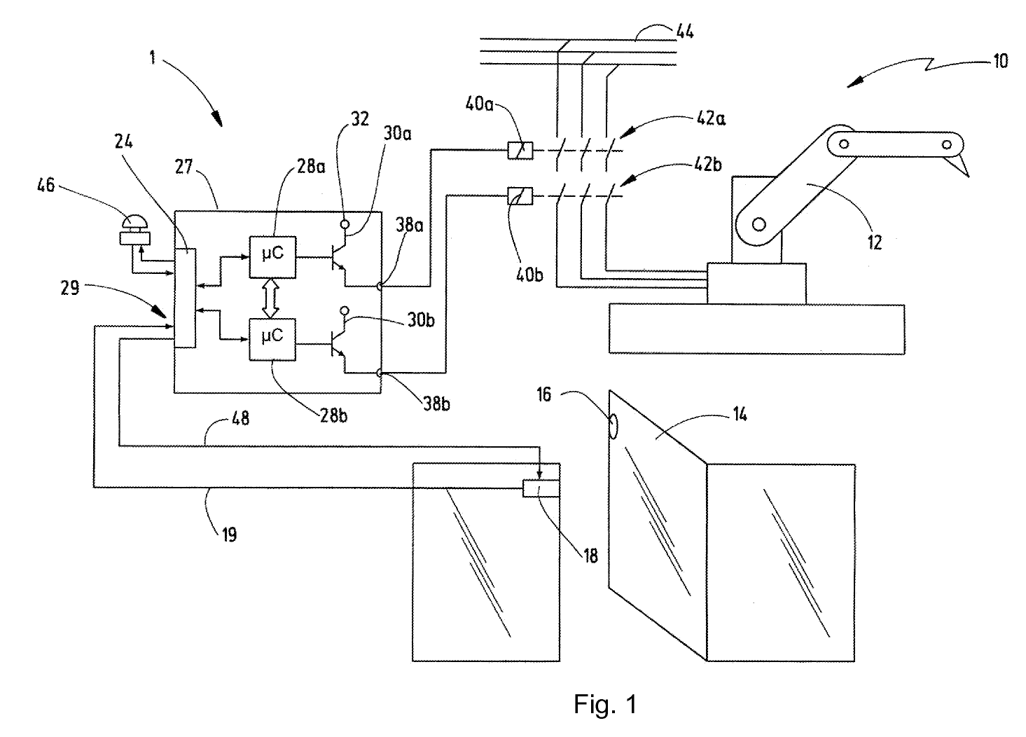

FIG. 1 illustrates a technical installation 10 with an exemplary embodiment of a safety switching device 1 according to the disclosure for the automated control of the technical installation 10. This illustration is intended to explain the functioning of a safety switching device 1 according to the disclosure.

A safety switching device 1 according to the disclosure is suitable in particular for the failsafe switching off of the installation 10, i.e. the safety switching device 1 is used for safety-related tasks. Safety switching devices of this type are frequently generally also referred to as control devices 1 for controlling a technical installation 10 in an automated manner.

The installation 10 comprises in this case in an exemplary manner a robot 12 whose movements during the working operation pose a risk to persons that are located in the working region of the robot 12. For this reason, the working region of the robot 12 is protected by a protective fence having a protective door 14. The protective door 14 renders it possible to access the working area of the robot 12 by way of example for maintenance work or for installation work. However, the robot 12 may only function during the normal working operation if the protective door 14 is closed. As soon as the protective door 14 is opened, the robot 12 must be switched off or transferred into a safe state in a different manner.

In order to detect the closed state of the protective door 14, a protective door switch having a door part 16 and a frame part 18 is attached to the protective door 14. The frame part 18 generates a protective door signal on a line 19 and said protective door signal is transmitted by way of the line 19 to the safety switching device 1.

In this exemplary embodiment, the safety switching device 1 comprises an input/output part 24 having a plurality of connections (or rather external or device connections) 29. In some exemplary embodiments, the connections 29 are connecting terminals or field terminals that are arranged on a housing face of the housing 27 of the safety switching device 1, by way of example on a connecting module part as will be explained hereinafter. These connections 29 render it possible to connect signaling devices or other sensors on the field plane. Accordingly, exemplary embodiments of the safety switching device 1 can be or can comprise field devices that are arranged outside a switching cabinet in the physical proximity of the robot 12.

The safety switch device 1 comprises in this exemplary embodiment two redundant signal processing channels. By way of example, two microcontrollers 28a, 28b are illustrated that are each connected to the input/output part 24. The microcontrollers 28a, 28b process in this case in a redundant manner with respect to one another the input signals that the safety switching device 1 receives at the device connections of the input/output part 24 and compares their results, as is illustrated by an arrow 29. In lieu of two microcontrollers 28a, 28b, it is possible to use microprocessors, ASICs, FPGAs and/or other signal processing circuits. It is preferred that exemplary embodiments of the safety switching device 1 comprise at least two signal processing channels that are redundant with respect to one another and that are each able to perform logic signal operations in order to generate a signal in response thereto. This signal is then used in order to control a switching element to switch off the technical installation 10 or the robot 12. A safety switching device 1 of this type can then be used for switching off the installation 10, in this case the robot 12, in a failsafe manner (FS).

In the case illustrated here, the safety switching device 1 comprises two redundant switching elements 30a, 30b. Each of these two switching elements is able to connect through a high voltage potential 32 to a device connection 38a, 38b of the safety switching device 1 in order to render it possible for current to flow to a protection device 40a, 40b or to interrupt this current flow. Consequently, each of the switching elements 30 can switch off an actuator, such as a protection device or a solenoid valve.

The protection devices 40a, 40b comprise working contacts 42a, 42b respectively. The working contacts 42a, 42b are arranged in this case in series with respect to one another in a current supply path from a current supply 44 to the robot 12. As soon as the control device 1 switches off the protection devices 40a, 40b, the contacts 42 become separated and the current supply to the robot 12 is switched off. It is clear to the relevant persons skilled in the art that a “radical” switch-off of this type is described in an exemplary manner. As an alternative thereto, it is possible in the case of a safety requirement to switch off only parts of the robot 12, such as the dangerous drives, whereas other parts of the robot 12 remain ready to function. A delayed switch-off is also feasible, so that the robot 12 can where necessary be decelerated in a controlled manner prior to switching off the drives.

The safety switching device 1 controls the switching elements 30a, 30b in this exemplary embodiment in response to the signal from the protective door switch on line 19 and in response to a further input signal from an emergency off button 46. The emergency off button 46 is also connected by way of lines to device connections of the control device 1. It is preferred that each of the input signals are present in a redundant manner or that rather in each case two input and output lines or connections can be provided (not illustrated in FIG. 1). In the example illustrated in FIG. 1, it is therefore possible to provide for the emergency off button 46 two input lines or inputs that each deliver an input signal from the emergency off button 46. This applies in a similar manner for the signal from the protective door switch.

In some exemplary embodiments, the safety switching device 1 generates output signals that are transmitted to the individual signaling devices. By way of example, an output signal of this type is transmitted by way of a line 48 to the frame part 18 of the protective door switch. The frame part 18 passes the output signal of the safety switching device 1 from the line 48 to the line 19 if the door part 16 is located in the proximity of the frame part 18, in other words if the protective door 14 is closed. The safety switching device 1 can therefore monitor the protective door switch with the aid of the output signal on the line 48 and with the aid of the input signal on the line 19. The control device 1 monitors the emergency off button 46 in a similar manner.

Deviating from the illustration in FIG. 1, two redundant output signals from the safety switching device 1 are frequently used in practice, said signals being transmitted in each case by way of a separate signal line to a signaling device and by way of this signaling device back to the safety switching device 1. By way of example for such an implementation process, reference is made to DE 10 2004 020 995 A1 that is included herein by reference with respect to the details of a process of this type for the redundant monitoring of a signaling device. Also, the emergency off button 46 is frequently monitored in practice using redundant input and output lines, as mentioned above.

In the exemplary embodiment illustrated in FIG. 1, the safety switching device 1 is used for safety-related tasks, in particular for switching off an installation in a failsafe manner (FS). However, the safety switching device 1 can also be used for non-safety related tasks or standard tasks (ST).

The safety switching device 1 can be in particular a programmable control device for a programmable control of the technical installation. As an alternative, the safety switching device 1 can also be a configurable control device. The term ‘configurable’ is understood to mean in this case the ability to be tailored or adjusted to suit a hardware component of the controller, such as by way of example a wiring system. The term ‘programmable’ is understood to mean in this case the ability to be tailored or adjusted to suit a software component of the controller, by way of example by means of a programming language.

It is preferred that the safety switching device 1 comprises at least one bus, in particular a communication bus and/or supply voltage bus. By way of example, the safety switching device 1 can be a decentralized control device whose components are mutually connected by way of a bus. The control device can comprise in particular a master module for coordinating the data traffic on the communication bus. In the case of a safety switching device 1 for safety-related tasks, the (communication) bus can be by way of example a failsafe bus such as a safetyBUS p or PROFINET. In the case of a safety switching device 1 for standard tasks, the bus can be by way of example a standard fieldbus such as CANOpen or DeviceNet or similar.

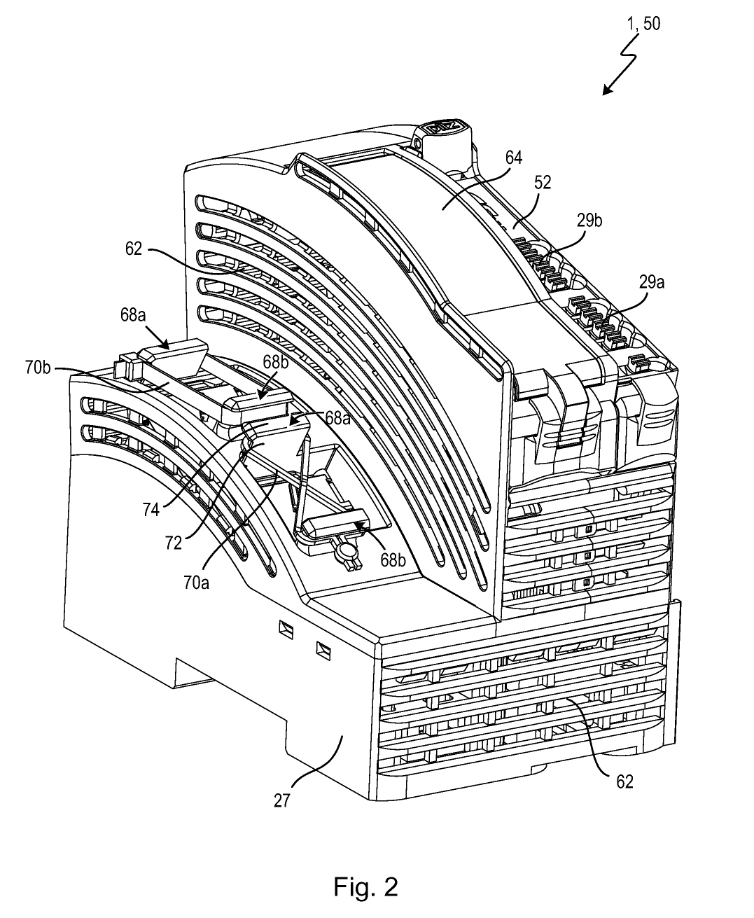

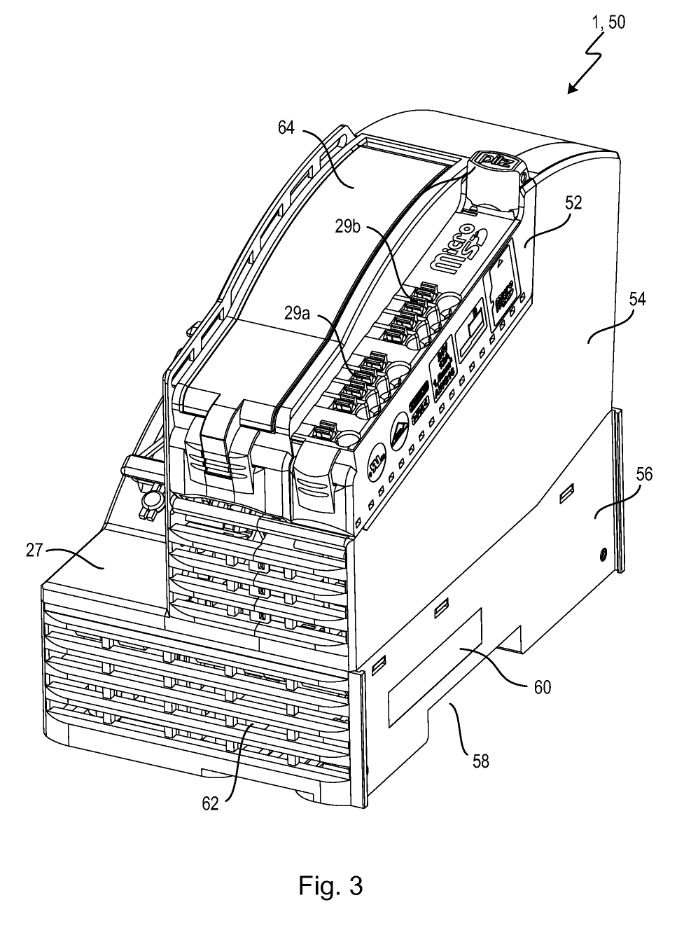

The different views in FIGS. 2 and 3 illustrate a so-called master module of the new safety switching device 1 that itself can also be referred to as the safety switching device 1. The master module 50 of the safety switching device 1 is preferably constructed in a modular manner that considerably simplifies the process of changing or rather replacing the individual parts. In accordance with the present exemplary embodiment, the master module 50 of the safety switching device 1 comprises in particular a connection module 52, an electronic module 54 and also a so-called bus- or back plane-module 56. As already mentioned, the safety switching device 1 is preferably arranged in a switching cabinet (not illustrated). This appears mainly by virtue of the fact that the back plane-module 56 is fastened to a metal top-hat rail. A fastening or clip mechanism (not further illustrated) that is arranged in the region of the reference numeral 58 is used to fasten the safety switching device 1 to the top-hat rail in a simple, mainly releasable manner. As already described above, signaling devices or other sensors on the field plane, such as emergency off button, protective door switch etc. can be either directly wired to the connection module 52 or can be connected by way of external I/O modules (not illustrated) by way of the (communication) bus 60 to the master module 50 of the safety switching device 1. In the case of larger installations, the number of the signaling devices that are to be controlled can be expanded in an almost arbitrary manner, in that additional I/O modules can be connected to the master module 50. These I/O modules (also referred to as input/out modules) communicate with the master module 50 by way of the (communication) bus 50. They are preferably likewise arranged on the top-hat rail in the switching cabinet to the side of the master module 50 and by way of example are connected directly to the master module 50 by way of a simple plug connection or indirectly by way of other I/O modules. The I/O modules in turn can be wired directly to the individual signaling devices (by way of example to a respective signaling device).

The connections 29 that are provided in the connection module and are referred to in this document generally also as inputs 29a and outputs 29b render it possible to wire the signaling devices, such as by way of example an emergency-off button, also directly to the master module 50. The connections 29a, b, can be by way of example spring clamp terminals or screw terminals. In other exemplary embodiments, the connections 29a, b can be plugs or sockets that comprise multiple contact elements (pins), wherein in each case a pin forms a connection. Frequently, M8 sockets that have five contact pins are used for connecting signaling devices or other sensors on the field plane.

The electronic module 54 that is integrated in the master module 50 comprises at least one processor that performs the electronic (data) processing and control logic operation of the safety switching device 1. Consequently, the input signals of the individual signal devices are either read out by way of the direct connections at the connection module 52 or by way of the communication Bus 60 by way of the I/O modules, and the actuators that are to be controlled, as already mentioned above, are controlled according to the programmable control logic operation

Moreover, reference is made to the following further features of the housing 27. It is preferred that multiple ventilation slits 62 are provided at the front or lateral faces of the housing 27 and said ventilation slits ensure that the inner space of the housing 27 is sufficiently ventilated and cooled. Furthermore, a labeling flap 64 is arranged on the upper face of the housing 27 and said labeling flap protects the labeling notices that are provided beneath said labeling flap and relate to the safety switching device 1 and/or relate to the occupation of the inputs and outputs 29a,b.

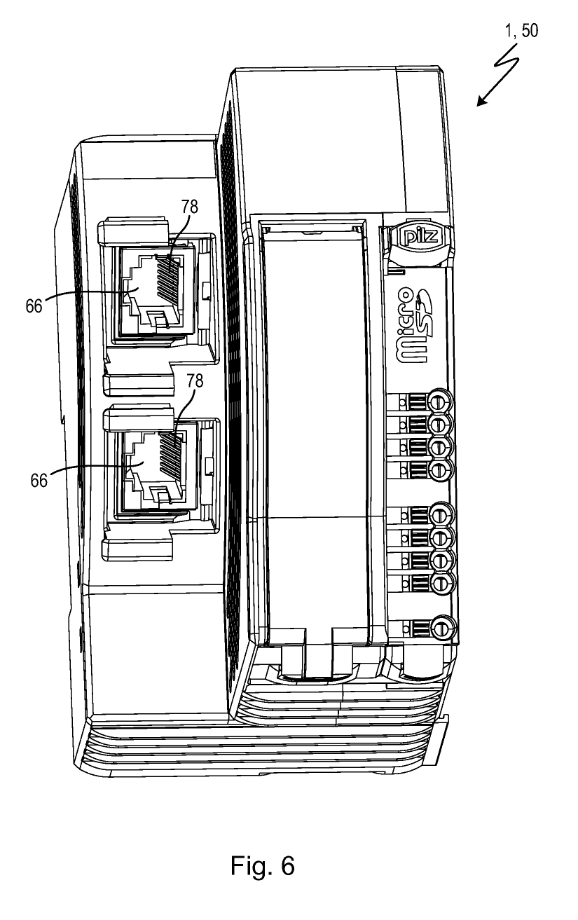

It is further evident from FIGS. 2 to 6 that two RJ interfaces 66 are arranged on the housing 27 of the safety switching device 1. The RJ interfaces 66 are evident in detail in FIG. 6. These RJ interfaces 66 are preferably RJ45 interfaces. They are used as user interfaces. It is thus possible with the aid of a commercially available Ethernet connection to connect by way of example visualization systems, laptops, computers or other reading devices directly to the master module 50 of the safety switching device 1. In addition, these interfaces 66 are used for programming and parameterizing the safety switching device 1 via Ethernet.

Generally, one RJ interface 66 would be sufficient. A second RJ interface 66, as is illustrated with reference to the illustrated exemplary embodiment, does however have the advantage that multiple safety switching devices can be mutually connected (via Ethernet cable) by way of the second RJ interface 66, so that in this manner multiple safety switching devices can be simultaneously read out, programmed or parameterized by way of the first RJ interface.

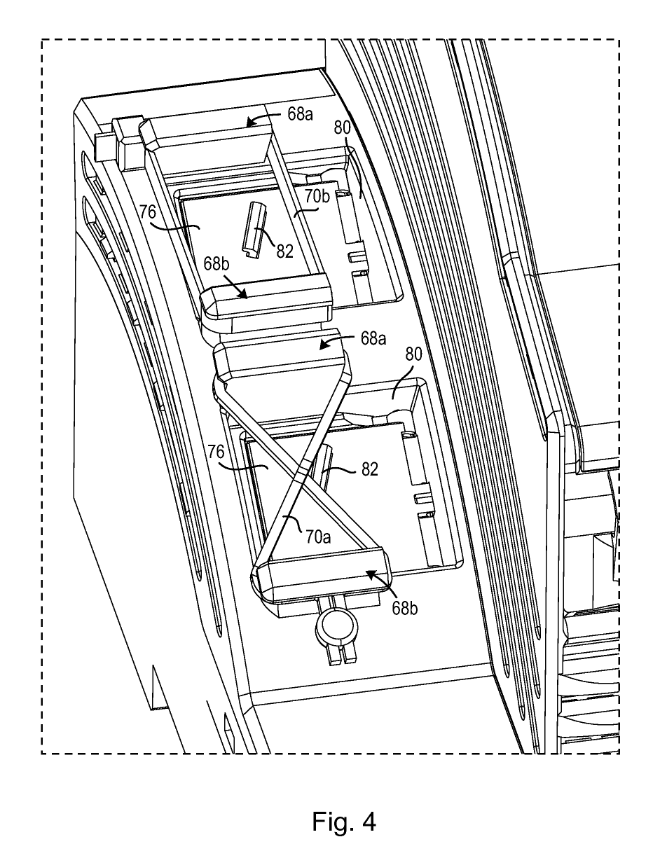

As is illustrated in FIG. 3 and in detail in FIG. 4, a first bar 68a is provided on a first side of the RJ interfaces 66 and a second bar 68b is provided on a second opposite side of the RJ interface 66. It is preferred that both bars 68a,b protrude in an orthogonal manner from the housing 27. As is illustrated in FIGS. 3 and 4, the two bars 68a,b are used to mount a securing element 70a,b thereto.

In the present case, two different securing elements 70a,b are illustrated in an exemplary manner and said securing elements are mounted to the two bars 68a,b or rather are wound around said bars. The securing element 70a is a seal. However, the securing element 70b is a commercially available cable tie. By virtue of arranging the two bars 68a,b on opposite lying sides of the RJ interfaces 66, the securing elements 70a,b cover the region of the RJ interfaces 66 in the assembled state and consequently prevent access thereto. In other words, as long as an RJ plug is not connected to the interfaces 66 and the securing elements 70a,b are mounted on the bars 68a,b, the RJ interfaces 66 are not accessible. Consequently, the safety switching device 1 can only be read out, programmed or parameterized after the securing element 70a,b has been released.

Even though it is quite possible to remove seals 70a or cable ties 70b of this type using the appropriate equipment, as a consequence, a degree of manipulation protection of the safety switching device 1 is nonetheless ensured. In the case of a closed state illustrated in FIGS. 3 and 4, a user receives immediately the visual signal that a “tapping” of the RJ interfaces 66 is not desired. In particular, it is also ensured in the case of a seal 70a that it is hardly possible for the “tapping” of the safety switching device 1 to go unnoticed, since it would be possible after the event to recognize that the seal 70a had been broken.

In order to ensure that the securing element 70a,b is easy to handle and is mounted in a mechanically stable manner, the bars 68a,b preferably comprise an L-shaped profile. The first bar 68a comprises for this purpose a first section 72 that protrudes from the housing 27 and a second section 74 that extends transverse to said first section and is arranged on the end of the first section 72 that is remote from the housing 27. The second bar 68b comprises in the same manner a third section 72 that protrudes from the housing 27 and a fourth section 74 that extends transverse to said third section and is arranged on the end of the third section 72 that is remote from the housing 27. The first section 72 of the first bar 68a thus corresponds to the third section 72 of the second bar 68b. The second section 74 of the first bar 68a thus corresponds to the fourth section 74 of the second bar 68b. The second and the fourth section 74 bars 68a,b preferably face away from one another, in other words outwards when viewed from the RJ interface 66. The transverse sections 74 thus prevent the securing element 70a,b from being removed (desired or undesired) upwards from the bars 68a,b. In order to prevent damage, the bars 68a,b are preferably embodied in an in part elastic or rather resilient manner. As a result, said bars can yield a little during the process of assembling a securing element 70a,b.

As is further evident in particular in FIG. 4, the RJ interfaces 60 are covered in accordance with the illustrated embodiment in addition by a protective flap 76. These protective flaps 76 are not only used as a means of preventing access to the RJ interfaces 66 but rather are also used as additional dust protection. In the closed state, it is possible as a consequence to prevent contamination or even corrosion of the contacts 78 of the RJ interfaces 66.

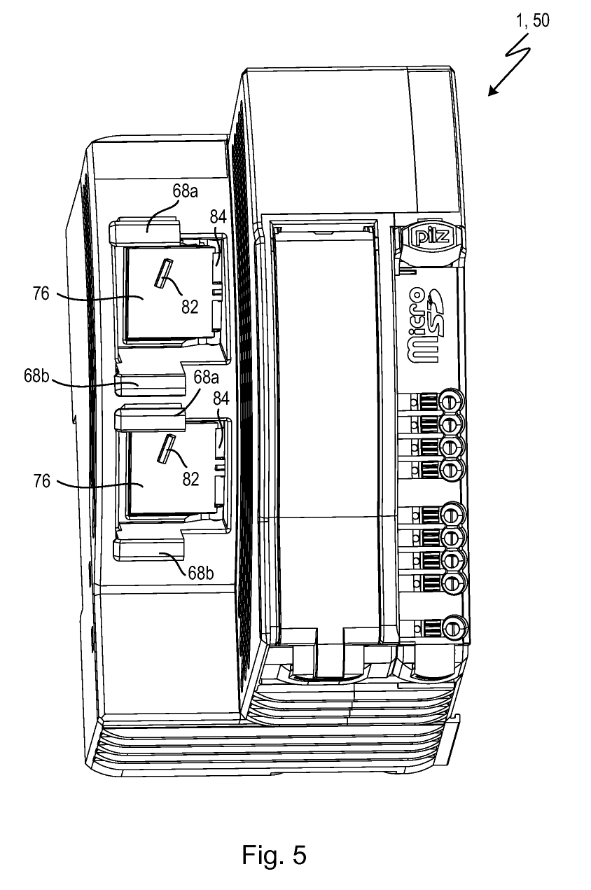

A further protection of the RJ interfaces 66 is achieved by virtue of the fact that each of said RJ interfaces are arranged in a recess 80. In the present exemplary embodiment, the said bars 68a,b lead directly into the recess 80, as a result of which a relatively space-saving arrangement is ensured. However, it goes without saying that the bars 68a,b can also be (slightly) spaced apart from the recess 80. In order to open the protective flaps 76 when the securing element 70a,b has been released and to obtain access to the RJ interfaces 66, said protective flaps can be flipped up. A handle or lever 82 that is attached to said protective flap renders it possible to flip up said protective flap in a simple manner. An articulated axle 84 (see in particular FIG. 5) is attached to the housing 27 for this purpose and the protective flap 66 can be rotated or rather flipped up about said articulated axle.

Reference is made above in particular to the function and advantages of the bars 68a,b and also of the securing elements 70a,b that are arranged on said bars with the protective flap 76 in the closed state. However, the bars 68a,b also fulfill an advantageous purpose even when the protective flaps 76 are in the open state. In particular, if in order to read out, program or parameterize the safety switching device 1 corresponding devices are connected to the RJ interfaces 66 by way of an RJ plug (RJ45 cable and plug), the RJ plug can be additionally fastened with the aid of the bars 68a,b and the securing elements (in this case preferably with the aid of cable ties 70b). This prevents in particular the RJ plug being unintentionally removed and thus acts as an additional vibration protection.

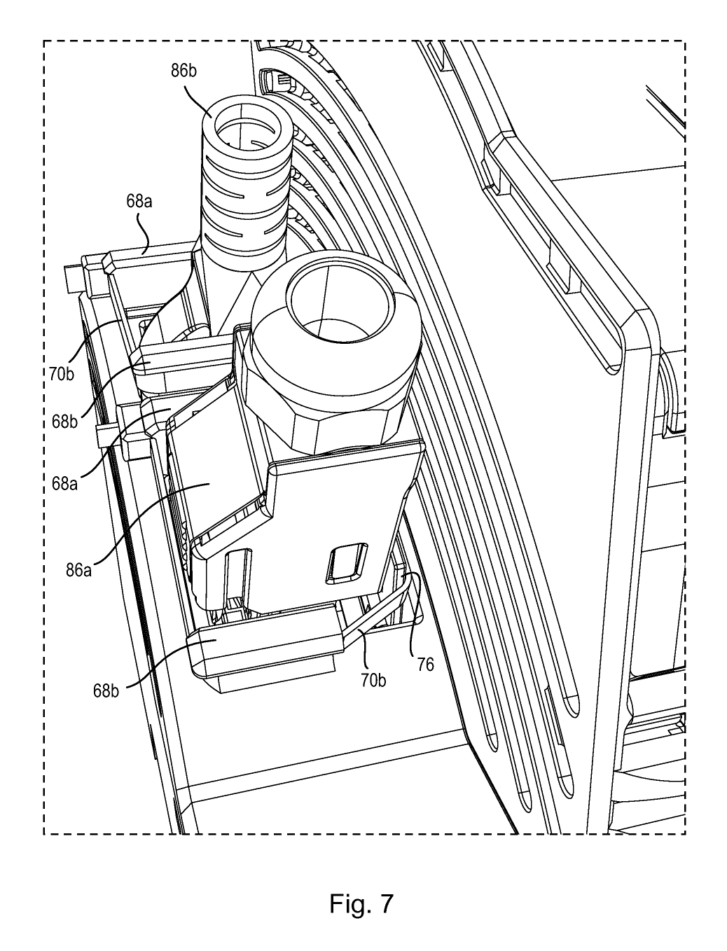

The latter mentioned situation is illustrated in detail in FIG. 7. It is evident from FIG. 7 that the inserted RJ plug 86a,b can be additionally secured by means of the cable tiles 70b that are tensioned around the bars 68a,b. In this situation, the protective flaps 76 are naturally open. It is to be mentioned at this point that the protective flaps 76 preferably have two mechanically defined positions, namely a closed position (as illustrated in FIG. 5) and a mechanically defined open position (as illustrated in FIG. 7). In order to secure the RJ plug 86a,b, the cable ties 70b are preferably tensioned not only around the two bars 68a,b but rather are also tensioned around the respective protective flap 76. In this manner, the protective flap 76 exerts an additional pressure on the RJ plug 86a,b that pushes the RJ plug 86a,b in addition into the RJ interface 66.

In an advantageous manner, the articulated axle 84 of the protective flap 76 is arranged on the same side of the recess 80 as the contacts 78 of the RJ interface 66. This has the advantage that the pressure that is exerted by means of the cable tie 70b on the protective flap 76 and as a consequence in turn on the RJ plug 84a,b induces a tilting moment that pushes the contacts of the RJ plug 86a,b in the direction of the contacts 78 of the RJ interfaces 66. As a consequence, the contact reliability is improved immensely.

As is furthermore evident in FIG. 7, both conventional RJ45 plugs 86b and also slightly modified RJ45 plugs 86a are suitable. The slightly modified RJ45 plug 86b comprises in comparison to the commercially available RJ45 plug 86a a slightly widened and more robust plug housing. This facilitates on the one hand the above described tensioning with the aid of the cable tie 70b and on the other hand increases the robustness with respect to possible damage.

What is claimed is:

1. A safety switching device for controlling a technical installation in an automated manner, comprising:
a housing,
an input which is configured to receive an input signal,
a processing unit which is configured to process the input signal and to generate a control signal,
an output which is configured to output the control signal to an actuator,
an RJ interface arranged at the housing,
a first bar which is arranged on a first side of the RJ interface, wherein the first bar comprises a first section that protrudes from the housing and a second section that extends transverse to said first section, wherein the second section is arranged on an end of the first section that is remote from the housing; and
a second bar which is arranged on a second side of the RJ interface opposite the first side, wherein the second bar comprises a third section that protrudes from the housing and a fourth section that extends transverse to said third section, wherein the fourth section is arranged on an end of the third section that is remote from the housing.

2. The safety switching device as claimed in claim 1, wherein the first section and the third section extend parallel to one another.

3. The safety switching device as claimed in claim 2, wherein the second section extends perpendicular to the first section, and wherein the fourth section extends perpendicular to the third section.

4. The safety switching device as claimed in claim 3, wherein each of the first and the second bar comprises an essentially L-shaped profile.

5. The safety switching device as claimed in claim 4, wherein the second section extends, starting from the first section, along a first direction, an wherein the fourth section extends, starting from the third section, along a second direction opposite the first direction.

6. The safety switching device as claimed in claim 1, further comprising a protective cover for covering the RJ interface.

7. The safety switching device as claimed in claim 6, wherein the protective cover comprises a hinged flap which is pivotally supported on the housing by means of an articulated joint having an articulated axle, wherein the articulated axle extends transverse to the first and the second bar.

8. The safety switching device as claimed in claim 7, wherein the protective flap comprises an elastic material.

9. The safety switching device as claimed in claim 7, wherein the RJ interface comprises one or more contacts, wherein the housing comprises a recess that extends between the first and the second bar, and wherein both the RJ interface and the articulated axle are arranged in the recess on a first side of an imaginary center line of said recess, wherein said imaginary center line extends transverse to the first and second bar and divides the recess in two parts of equal size.

10. The safety switching device as claimed in claim 9, wherein the first section of the first bar and the third section of the second bar lead into the recess or adjoin said recess.

11. The safety switching device as claimed in claim 1, further comprising a securing element which is mounted to the first bar and the second bar.

12. The safety switching device as claimed in claim 11, wherein the securing element is a cable tie or a seal.

13. A safety switching device for controlling a technical installation in an automated manner, comprising:
a housing,
an input which is configured to receive an input signal,
a processing unit which is configured to process the input signal and to generate a control signal,
an output which is configured to output the control signal to an actuator,
an RJ interface comprising one or more contacts and being arranged at the housing,
a first bar which protrudes from the housing and is arranged on a first side of the RJ interface;
a second bar which protrudes from the housing and is arranged on a second side of the RJ interface opposite the first side, and
a protective cover for covering the RJ interface, wherein the protective cover comprises a hinged flap which is pivotally supported on the housing by means of an articulated joint having an articulated axle, wherein the articulated axle extends transverse to the first and the second bar,
wherein the housing comprises a recess that extends between the first and the second bar, and wherein both the RJ interface and the articulated axle are arranged in the recess on a first side of an imaginary center line of said recess, wherein said imaginary center line extends transverse to the first and the second bar and divides the recess in two parts of equal size.

14. The safety switching device as claimed in claim 13, wherein the first bar comprises a first section that protrudes from the housing and a second section that extends transverse to said first section, wherein the second section is arranged on an end of the first section that is remote from the housing, and wherein the second bar comprises a third section that protrudes from the housing and a fourth section that extends transverse to said third section, wherein the fourth section is arranged on an end of the third section that is remote from the housing.

15. The safety switching device as claimed in claim 14, wherein the first section and the third section extend parallel to one another.

16. The safety switching device as claimed in claim 15, wherein the second section extends perpendicular to the first section, and wherein the fourth section extends perpendicular to the third section.

17. The safety switching device as claimed in claim 16, wherein each of the first and the second bar comprises an essentially L-shaped profile.

18. The safety switching device as claimed in claim 17, wherein the second section extends, starting from the first section, along a first direction, an wherein the fourth section extends, starting from the third section, along a second direction opposite the first direction.

19. The safety switching device as claimed in claim 13, further comprising a securing element which is mounted to the first bar and the second bar, wherein the securing element is a cable tie or a seal.

20. A safety switching device for controlling a technical installation in an automated manner, comprising:
a housing,
an input which is configured to receive an input signal,
a processing unit which is configured to process the input signal and to generate a control signal,
an output which is configured to output the control signal to an actuator,
an RJ interface arranged at the housing,
a first bar which protrudes from the housing and is arranged on a first side of the RJ interface;
a second bar which protrudes from the housing and is arranged on a second side of the RJ interface opposite the first side, and
a securing element which is mounted to the first bar and the second bar, wherein the securing element comprises a cable tie or a seal.
